(19) United States
(12) Patent Application Publication
(10) Pub. No.: US 2009/0148096 A1
(43) Pub. Date: Jun. 11, 2009

(54) OPTICAL INTERCONNECTION DEVICE

(75) Inventor: Takanori YAMAMOTO, Nagano (JP)

Correspondence Address: DRINKER BIDDLE & REATH (DC), 1500 K STREET, N.W., SUITE 1100, WASHINGTON, DC, 20005-1209, US

(73) Assignee: SHINKO ELECTRIC INDUSTRIES CO., LTD.

(21) Appl. No.: 12/326,483

(22) Filed: Dec. 2, 2008

(30) Foreign Application Priority Data
Dec. 3, 2007 (JP) 2007-312438

(51) Int. Cl. G02B 6/122; G02B 6/12

(52) U.S. Cl. 385/14

(57) ABSTRACT

An optical interconnection device is provided. The optical interconnection device includes an optical component and a substrate on which the optical component is surface-mounted. The substrate includes: an optical waveguide which is formed in the substrate and which includes a core layer, and a cladding layer covering the core layer; and an optical path changing portion provided adjacent to one end portion of the optical waveguide to change an optical path of light transmitted through the optical waveguide or an optical path of light communicated by the optical component. A width of the core layer is broadened toward the optical path changing portion, when viewed from a plane which is parallel with a surface of the substrate.

This application claims priority from Japanese Patent Application No. 2007-312438, filed on Dec. 3, 2007, the entire contents of which are hereby incorporated by reference.

### BACKGROUND

1. Technical Field

The present disclosure relates to an optical interconnection device. More particularly, the present disclosure relates to an optical interconnection device on which an optical component such as a light receiving element and a light emitting element are mounted.

2. Related Art

With enhancement of the signal speed, increase of the packaging density or the like of the digital equipment, the measures against the noise and the EMI on the electric signal is required. As the measures, an optical/electrical hybrid substrate in which a part of electric wiring is replaced with an optical signal is now being developed.

In the related art, in the case where an optical component such as a laser diode, a photodiode is mounted on the optical/electrical hybrid substrate, in particular, a surface mounting optical component in which light is incident/transmitted in a direction perpendicular to a surface of the substrate is mounted on the substrate, an optical coupling loss is caused in accordance with an offset of an optical axis of several μm occurring between an optical waveguide core and the optical component or an optical path changing portion, and thus an optical signal is degraded.

In order to solve the above problem, for example, JP-A-2001-141965 describes an optical coupler that can optically couple optical devices effectively with a simple structure and also can easily attain a size reduction and an array configuration. Also, JP-A-2001-141965 describes an optical coupler in which a first optical device and a second optical device are optically coupled by an elliptical mirror that is constructed by a part of an almost elliptical sphere as a method of fabricating the optical coupler with good productivity.

As shown in FIG. 1, in JP-A-2001-141965, a first optical device 100 is constructed by mounting a vertical cavity surface emitting laser (VCSEL) 102 on a substrate 104. The first optical device 100 is mounted on a second optical device 200 via an adhesive 150. The second optical device 200 includes an optical waveguide 204 and a reflecting mirror 206 formed in an elliptical concave portion 208. A laser beam emitted from the VCSEL 102 is incident in a direction perpendicular to the second optical device 200. An optical path of the beam is changed by 90 degree and converged by the elliptical reflecting mirror 206 serving as an optical path changing portion. The laser beam is optically coupled to a core layer 210 of the optical waveguide 204 positioned near a focal point of reflecting mirror 206.

The laser beam emitted from the VCSEL 102 is shaped like a circular cone. Therefore, such laser beam is reflected by the reflecting mirror 206, which is shaped like an elliptical sphere and arranged at 45° with respect to the incident direction of the laser beam, by an angle of 90°. Also, the reflected beam is shaped like a circular cone similarly to the incident light. Then, the reflected beam is converged near an incident end of the core layer 206 of the optical waveguide 204, and then is transmitted through the optical waveguide 204. According to this configuration, an optical coupling efficiency between the VCSEL 102 (first optical device) and the optical waveguide 204 (second optical device) can be improved. Also, in FIG. 1, a reference numeral 207 denotes a cladding layer of the optical waveguide 204.

However, in JP-A-2001-141965, the reflecting mirror 206 must be shaped like the elliptical concave portion 208. Therefore, it takes much time and labor to form the reflecting mirror, and also it is difficult to control positioning and arrangement of the reflecting mirror having the elliptical concave portion, and also it is needed to align the optical waveguide with the reflecting mirror.

Also, as another related art, JP-A-2006-47764 describes an optical/electrical hybrid substrate. In the optical/electrical hybrid substrate, there is provided an optical waveguide that can provide the optical coupling simply and highly efficiently upon coupling the optical circuits. According to this configuration, the projection-like optical waveguide is inserted into the hole of the optical/electrical hybrid substrate. The light emitted from the VCSEL enters the projection-like optical waveguide, and then is transmitted through the projection-like optical waveguide. As shown in FIG. 2A, when the optical path changing portion is formed in the optical waveguide, the light emitted from the VCSEL is converged to the core layer of the optical waveguide via the projection-like optical waveguide. Also, as shown in FIG. 2B, when the optical path changing portion is not formed in the optical waveguide, the light emitted from the VCSEL is coupled to the core layer of the optical waveguide by a micromirror that is formed in the projection-like optical waveguide.

In FIGS. 2A and 2B, 307 denotes a circuit substrate, 311 denotes a projection-like optical waveguide, 312 denotes a VCSEL, 313 denotes an optical waveguide, 314 denotes an optical/electrical hybrid substrate, 315 denotes a cutting surface, 320 denotes a traveling direction of light, 321 denotes a micromirror, and 322 denotes a light.

In the optical/electrical hybrid substrate described in JP-A-2006-47764, the projection-like optical waveguide must be fabricated by the individual process, and thus this substrate is disadvantageous to a mass-production and a cost reduction. Also, the projection-like optical waveguide must be fitted into the hole that is formed in advance, and thus the number of steps is increased. Further, when the micromirror is formed in the projection-like optical waveguide, such micromirror must be aligned precisely upon mounting such that the light reflected by the micromirror is coupled to the core layer of the optical waveguide.

In the above related arts (JP-A-2001-141965 and JP-A-2006-47764), the separate processes are needed to form the optical path changing portion, and also a high alignment precision is required for the optical path changing portion itself. Therefore, an optical interconnection device and a manufacturing method thereof is disadvantageous to a mass-production and a cost reduction.

### SUMMARY OF THE INVENTION

Exemplary embodiments of the present invention address the above disadvantages and other disadvantages not described above. However, the present invention is not required to overcome the disadvantages described above, and thus, an exemplary embodiment of the present invention may not overcome any of the problems described above.

Exemplary embodiments of the present invention provides an optical interconnection device that includes: a substrate having an optical waveguide; and a surface-mounted optical component such as a light emitting element or a light receiving element being mounted on the substrate.

According to exemplary embodiments of the present invention, a core layer formed in the substrate is formed into a taper shape or parabolic shape, so that an optical loss caused in coupling or transmitting a light signal can be reduced and also the surface-mounted optical component can be aligned with the substrate with good precision upon mounting them.

According to one or more aspects of the present invention, an optical interconnection device is provided. The optical interconnection device includes an optical component and a substrate on which the optical component is surface-mounted. The substrate includes: an optical waveguide which is formed in the substrate and which includes a core layer, and a cladding layer covering the core layer; and an optical path changing portion provided adjacent to one end portion of the optical waveguide to change an optical path of light transmitted through the optical waveguide or an optical path of light communicated by the optical component. A width of the core layer is broadened toward the optical path changing portion, when viewed from a plane which is parallel with a surface of the substrate.

According to one or more aspects of the present invention, a part of the core layer is tapered toward the other end portion of the core layer, when viewed from the plane.

According to one or more aspects of the present invention, a part of the core layer is formed like a parabolic shape whose width is gradually broadened toward the optical path changing portion, when viewed from the plane.

According to one or more aspects of the present invention, the optical component is mounted on the substrate such that light communicated by the optical component is in a direction perpendicular to the surface of the substrate.

According to one or more aspects of the present invention, the optical path changing portion is a mirror that is formed integrally with the optical waveguide and is arranged at an angle of 45 degree with respect to the surface of the substrate, and the optical path changing portion is configured to change the optical path by 90 degree.

According to one or more aspects of the present invention, the optical component is a photodiode.

According to one or more aspects of the present invention, the optical component is a vertical cavity surface emitting laser (VCSEL).

According to one or more aspects of the present invention, the part of the core layer is positioned in the vicinity of the optical path changing portion.

According to one or more aspects of the present invention, the part of the core layer is positioned in the vicinity of the optical path changing portion.

According to exemplary embodiments of the present invention, the core width can be widened substantially by shaping the core profile near the mirror into a taper shape or a parabolic shape. Therefore, an optical coupling efficiency between the mirror and the core layer can be improved. Also, since the core width is widened, a mounting tolerance of the optical component in the direction parallel with the mirror can be increased. Also, since such variation of the core width can be handled only by changing a mask pattern used in exposing the core, the optical interconnection device of the present invention can be manufactured at a low cost.

### BRIEF DESCRIPTION OF THE DRAWINGS

In the accompanying drawings:

FIG. 1 is a view showing an optical interconnection device in the related art;

FIGS. 2A and 2B are views showing an optical interconnection device in the related art;

FIG. 3 is a plan view of an optical interconnection device on which a surface emitting element substrate is mounted, according to a first exemplary embodiment of the present invention;

FIG. 4 is a sectional view of an optical/electrical hybrid substrate on which the surface emitting element substrate is mounted, according to the first exemplary embodiment of the present invention;

FIG. 5 is a sectional view of an optical/electrical hybrid substrate on which the surface emitting element substrate is not mounted, according to the first exemplary embodiment of the present invention;

FIG. 6 is a plan view of the optical/electrical hybrid substrate on which the surface emitting element substrate is not mounted, according to the first exemplary embodiment of the present invention;

FIG. 7 is a sectional view of an optical waveguide substrate on which the surface emitting element substrate is not mounted, according to the first exemplary embodiment of the present invention;

FIG. 8 is a sectional view of the optical waveguide substrate on which the surface emitting element substrate is mounted, according to the first exemplary embodiment of the present invention;

FIG. 9 is a plan view of an optical interconnection device on which a surface emitting element substrate is mounted, according to a second exemplary embodiment of the present invention;

FIG. 10 is a sectional view of an optical/electrical hybrid substrate on which the surface emitting element substrate is mounted, according to the second exemplary embodiment of the present invention;

FIG. 11 is a sectional view of an optical/electrical hybrid substrate on which the surface emitting element substrate is not mounted, according to the second exemplary embodiment of the present invention;

FIG. 12 is a plan view of the optical/electrical hybrid substrate on which the surface emitting element substrate is not mounted, according to the second exemplary embodiment of the present invention;

FIG. 13 is a sectional view of an optical waveguide substrate on which the surface emitting element substrate is not mounted, according to the second exemplary embodiment of the present invention;

FIG. 14 is a sectional view of the optical waveguide substrate on which the surface emitting element substrate is mounted, according to the second exemplary embodiment of the present invention; and

FIG. 15 is a detailed sectional view showing a mounting portion of the surface emitting element.

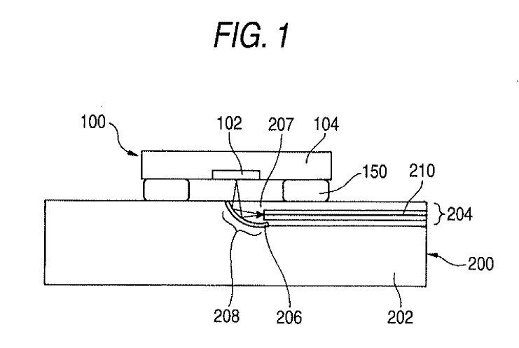

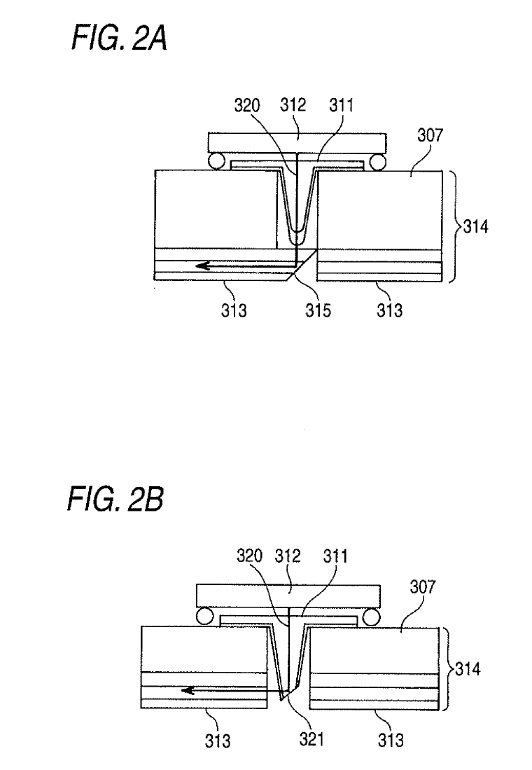

### DETAILED DESCRIPTION OF EXEMPLARY EMBODIMENTS OF THE INVENTION

Exemplary embodiments of the present invention will be now described in detail with reference to the accompanying drawings.

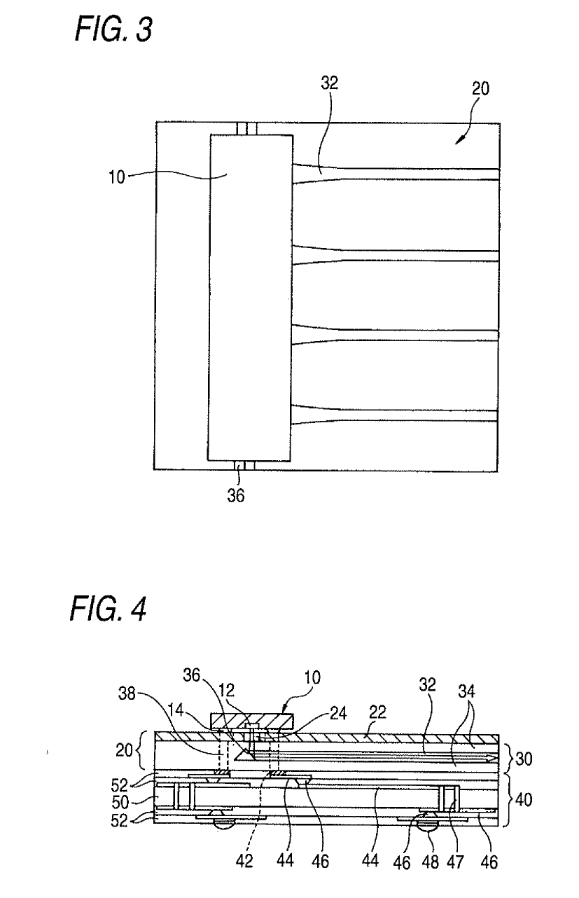

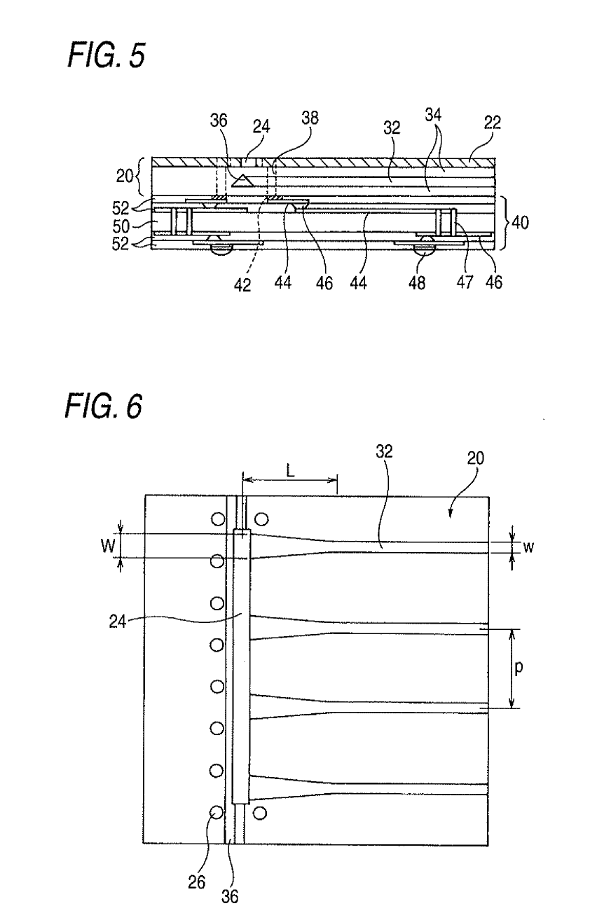

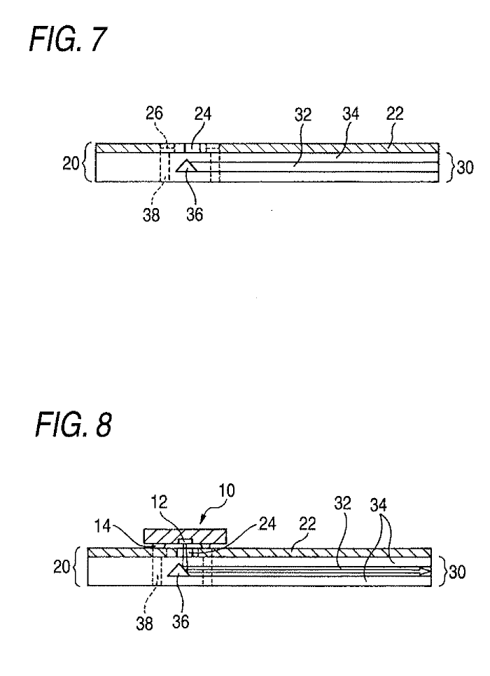

FIGS. 3 to 8 show a first exemplary embodiment of the present invention. FIG. 3 is a plan view of an optical interconnection device on which a substrate having a surface emitting element thereon (hereinafter called as “surface emitting element substrate”) is mounted. FIG. 4 is a sectional view of an optical/electrical hybrid substrate on which the surface emitting element substrate is mounted. FIG. 5 is a sectional view of an optical/electrical hybrid substrate on which the surface emitting element substrate is not mounted. FIG. 6 is a plan view of the optical/electrical hybrid substrate on which the surface emitting element substrate is not mounted. FIG. 7 is a sectional view of an optical waveguide substrate on which the surface emitting element substrate is not mounted. FIG. 8 is a sectional view of the optical waveguide substrate on which the surface emitting element substrate is mounted.

Firstly, in FIG. 3 and FIG. 4, a surface emitting element substrate 10 may be formed of a GaAs substrate on which a light emitting element such as a laser diode (e.g., a vertical cavity surface emitting laser (VCSEL) 12) or a light receiving element such as a photodiode is mounted. The surface emitting element substrate 10 has a substantially rectangular shape when viewed from a plan view as shown in FIG. 3, and the VCSEL 12 is arranged in an almost center portion of a lower surface in the width direction when viewed from a sectional view as shown in FIG. 4. The VCSELs 12 are arranged like an array in four locations, for example, at an equal interval in the longitudinal direction of the surface emitting element substrate 10.

As shown in FIG. 4, terminals 14 are arranged on both sides of the VCSEL 12 on a lower surface of the surface emitting element substrate 10. The terminal 14 is arranged in two front locations and two rear locations of each VCSEL 12 respectively, i.e., four terminals 14 are arranged in total every the VCSEL 12.

An optical waveguide substrate 20 is constructed by forming a solder resist layer 22 on an upper surface of an optical waveguide layer 30. The optical waveguide layer 30 consists of core layers 32, and cladding layers 34 covering the core layers 32. The core layers 32 are extended to an end surface of the substrate 20 and are provided in parallel at an interval that corresponds to an interval at which the VCSELs 12 are arranged.

An optical opening portion 24 is formed in the solder resist layer 22 (see FIG. 6 and FIG. 7). The optical opening portion 24 is extended in an arrangement direction along which the VCSEL 12 is arranged in a state where the surface emitting element substrate 10 is mounted on the optical waveguide substrate 20.

A 45-degree mirror 36 serving as an optical path changing portion is provided substantially under the optical opening portion 24 and the 45-degree mirror 36 is adjacent to the end portions of the core layers 32. The 45-degree mirror 36 is also arranged to extend in the direction along which the optical opening portion 24 is extended. The 45-degree mirror 36 is formed as a reflecting mirror on both sides at an angle of 45 degree in a sectional view in FIG. 7, for example.

In FIG. 7 and FIG. 8, pads 26 are formed in the solder resist layer 22 to correspond to the terminals 14 of the surface emitting element substrate 10. Also, through vias 38 are formed in via holes, which are formed to pass through the optical waveguide layer 30, in positions of the optical waveguide layer 30 corresponding to the terminals 14 and the pads 26 respectively, and are connected electrically to the pads 26. Also, when the surface emitting element substrate 10 is mounted on the optical waveguide substrate 20, the terminals 14 of the surface emitting element substrate 10 are connected electrically to the through vias 38 via the pads 26.

For example, the optical waveguide layer 30 is formed of the polymer-based material, the cladding layers 34 are formed by a laminating process such as a lamination, and the core layers 32 are formed in exposing/developing processes using photolithography. Also, the 45-degree mirror 36 is formed by the photolithography, or the like. In this case, positional relationships between the forming location of the 45-degree mirror 36 and the core layers 32 are decided depending on a mask used in exposing the core layers. Therefore, basically an alignment between the 45-degree mirror 36 and the core layers 32 is not needed.

In FIG. 4 and FIG. 5, an electric wiring substrate 40 is coupled integrally with the optical waveguide substrate 20. In the electric wiring substrate 40, 42 denotes a connection pad, 44 denotes a conductor pattern, 46 denotes a connection via, 47 denotes a through via, 48 denotes an external connection terminal, 50 denotes a core layer, and 52 denotes a resin layer. When the through vias 38 of the optical waveguide substrate 20 are bonded to the connection pads 42 of the electric wiring substrate 40, the electric wiring substrate 40 and the optical waveguide substrate 20 are electrically connected to each other.

In the first embodiment of the present invention, the core layers 32 of the optical waveguide layer 30 are tapered from the area that is close to the 45-degree mirror 36 toward the end portion of the optical waveguide layer 30, when viewed from the plane which is parallel with the surface of the optical waveguide layer 30 (in plane direction of the optical waveguide layer 30).

More particularly, in FIG. 6, a width W of the core end portion, which is adjacent to the 45-degree mirror 36, is larger than a core width w (W>w). Normally, a ratio of the width w to the width W is set to about two to three times. Also, a ratio of a length L of the tapered area to the core width w is set to about five to ten times. Also, a pitch P between the core layers 32 each arranged in parallel at an equal interval in the optical waveguide layer 30 is set to about 250 μm.

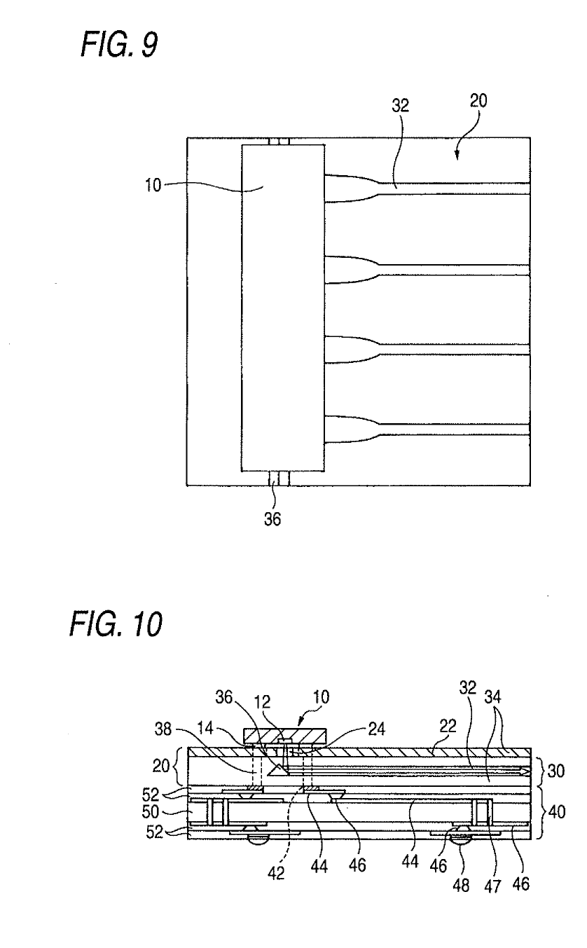

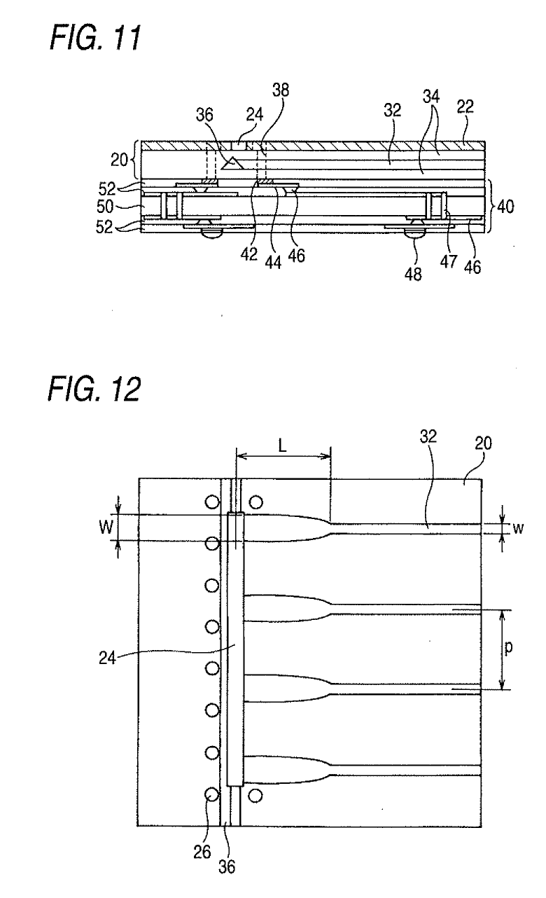

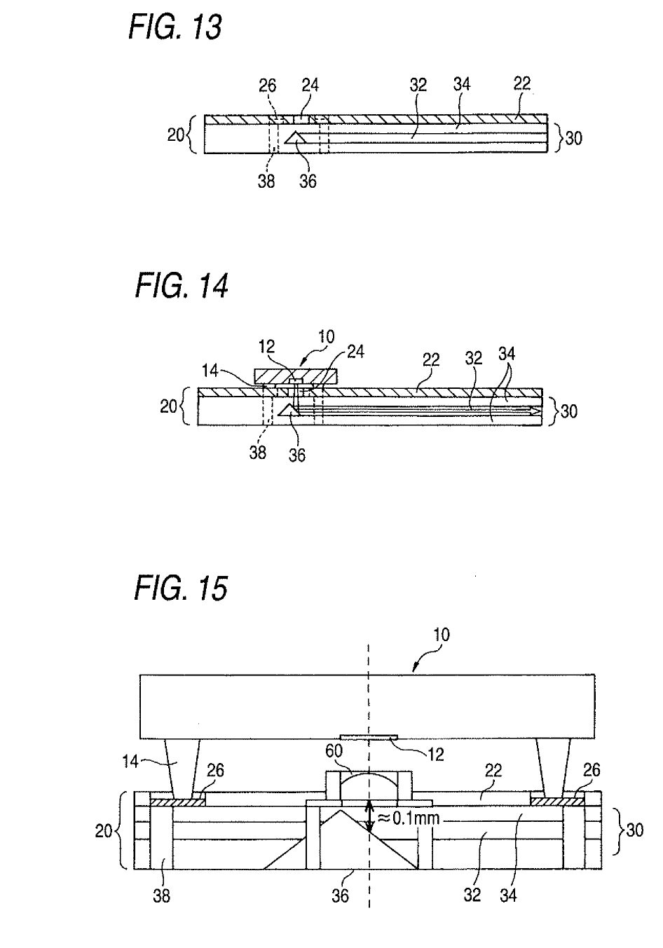

FIG. 9 to FIG. 14 show a second exemplary embodiment of the present invention. FIG. 9 is a plan view of an optical interconnection device on which a substrate having a surface emitting element thereon (surface emitting element substrate) is mounted. FIG. 10 is a sectional view of an optical/electrical hybrid substrate on which the surface emitting element substrate is mounted. FIG. 11 is a sectional view of an optical/electrical hybrid substrate on which the surface emitting element substrate is not mounted. FIG. 12 is a plan view of an optical/electrical hybrid substrate on which the surface emitting element substrate is not mounted. FIG. 13 is a sectional view of an optical waveguide substrate on which the surface emitting element substrate is not mounted. FIG. 14 is a sectional view of an optical waveguide substrate on which the surface emitting element substrate is mounted. In other words, FIG. 9 to FIG. 14 in the second embodiment correspond to FIG. 3 to FIG. 8 in the first embodiment respectively.

For this reason, in the second exemplary embodiment of the present invention, only differences from the first exemplary embodiment will be described with reference to FIG. 9 to FIG. 14 hereunder. As described above, in the first exemplary embodiment of the present invention, the core layers 32 of the optical waveguide layer 30 are tapered from the area that is close to the 45-degree mirror 36 toward the end portion of the optical waveguide layer 30, when viewed from the plane which is parallel with the surface of the optical waveguide layer 30 (in plane direction of the optical waveguide layer 30). In contrast, in the second exemplary embodiment of the present invention, the core layers 32 of the optical waveguide layer 30 are formed like a parabolic shape whose width is broadened toward the end portion side in the area that is close to the 45-degree mirror 36, when viewed from the plane which is parallel with the surface of the optical waveguide layer 30.

More particularly, in FIG. 12, a width W of the core end portion which is adjacent to the 45-degree mirror 36 is larger than a core width w (W>w). Normally, a ratio of the width w to the width W is set to about two to three times. Also, like the case in the first exemplary embodiment, a ratio of a length L of this parabolic area 40 to the core width w is set to about five to ten times.

FIG. 15 is a sectional view showing in detail the portion in which the surface emitting element substrate is mounted on the optical waveguide substrate 20. A lense 60 is provided between the VCSEL 12 of the surface emitting element substrate 10 and the 45-degree mirror 36 of the optical waveguide substrate 20 respectively. A focal length required of this lens 60 is about 0.1 mm. Accordingly, the laser beam is emitted from the VCSEL 12 in the direction perpendicular to the surface of the optical waveguide substrate 20, then is reflected by the 45-degree mirror 36 to change its direction by 90 degree, and then is converged onto an incidence plane of the core layer 32.

The laser beam incident on the core layer 32 is optically transmitted through the core layer 32 of the optical waveguide layer 30. For example, the laser beam is optically coupled to an optical fiber (not shown) from an output end of the optical waveguide layer 30, for example. Otherwise, the laser beam is optically coupled to another optical waveguide (not shown).

According to the exemplary embodiments of the present invention, the core layer 32 located near the 45-degree mirror 36 is shaped like a tapered shape as shown in the first exemplary embodiment, or is shaped like a parabolic shape as shown in the second exemplary embodiment, so that the core width can be partially broadened. Therefore, an optical coupling efficiency between the optical component such as the VCSEL 12 and the optical waveguide layer 30 can be improved. Also, a mounting tolerance needed when the surface emitting element substrate 10 is mounted on the optical waveguide substrate 20 can be set largely. In other words, improvement of an optical coupling efficiency and loosing of a precision in surface-mounting the optical component can be attained. Furthermore, the core layer located near the 45-degree mirror 36 is shaped like a tapered shape or a parabolic shape, so that transverse-mode of light can be controlled in the optical waveguide layer 30.

Also, when the optical waveguide layer 30 is fabricated by the photolithography method as the representative fabricating method, the core can be formed only by changing a mask. Therefore, a cost reduction can be attained. Also, the optical coupling efficiency is improved so that the optical interconnection device can respond to such a situation that the core width of the linear optical waveguide connected to the tapered or parabolic core portion is narrowed. Therefore, miniaturization of the optical interconnection device or speedup of the light signal can be achieved.

Also, in the first exemplary embodiment and the exemplary second embodiment, the VCSEL 12 is used as the surface emitting element substrate 10. However, a light receiving element such as a photodiode may be used instead of the VCSEL 12. In this case, the light is transmitted from the optical waveguide side to the light receiving element side via the 45-degree mirror 36.

While the present invention has been shown and described with reference to certain exemplary embodiments thereof, it will be understood by those skilled in the art that various changes in form and details may be made therein without departing from the spirit and scope of the invention as defined by the appended claims. It is aimed, therefore, to cover in the appended claim all such changes and modifications as fall within the true spirit and scope of the present invention.

What is claimed is:

1. An optical interconnection device, comprising:
an optical component; and
a substrate on which the optical component is surface-mounted, the substrate comprising:
an optical waveguide which is formed in the substrate and which comprises a core layer, and a cladding layer covering the core layer; and
an optical path changing portion provided adjacent to one end portion of the optical waveguide to change an optical path of light transmitted through the optical waveguide or an optical path of light communicated by the optical component,
wherein a width of the core layer is broadened toward the optical path changing portion, when viewed from a plane which is parallel with a surface of the substrate.

2. The optical interconnection device according to claim 1, wherein a part of the core layer is tapered toward the other end portion of the core layer, when viewed from the plane.

3. The optical interconnection device according to claim 1, wherein a part of the core layer is formed like a parabolic shape whose width is gradually broadened toward the optical path changing portion, when viewed from the plane.

4. The optical interconnection device according to claim 2, wherein the optical component is mounted on the substrate such that light communicated by the optical component is in a direction perpendicular to the surface of the substrate.

5. The optical interconnection device according to claim 3,
wherein the optical path changing portion is a mirror that is formed integrally with the optical waveguide and is arranged at an angle of 45 degree with respect to the surface of the substrate, and
wherein the optical path changing portion is configured to change the optical path by 90 degree.

6. The optical interconnection device according to claim 5, wherein the optical component is a photodiode.

7. The optical interconnection device according to claim 5, wherein the optical component is a vertical cavity surface emitting laser (VCSEL).

8. The optical interconnection device according to claim 2, wherein said part of the core layer is positioned in the vicinity of the optical path changing portion.

9. The optical interconnection device according to claim 3, wherein said part of the core layer is positioned in the vicinity of the optical path changing portion.
